(19) United States
(12) Patent Application Publication
(10) Pub. No.: US 2025/0373032 A1
(43) Pub. Date: Dec. 4, 2025

(54) FAST SWITCH-OFF CIRCUIT FOR CHARGING TUBE OF BATTERY MANAGEMENT SYSTEM

(71) Applicant: Fremont Micro Devices Corporation, Shenzhen (CN)

(72) Inventors: Guiyun Liu, Shenzhen (CN); Guomin Shi, Shenzhen (CN); Xinxin Ren, Shenzhen (CN)

(21) Appl. No.: 18/801,728

(22) Filed: Aug. 12, 2024

(30) Foreign Application Priority Data
Jun. 3, 2024 (CN) 202410709381.4

(51) Int. Cl. H02J 7/00

(52) U.S. Cl. CPC H02J 7/0029; H02J 7/00712

(57) ABSTRACT

Disclosed is a fast switch-off circuit for a charging tube of a battery management system, which includes a control circuit, a pull-down discharge circuit, and a discharge detection circuit. The control circuit synchronously switches on the pull-down discharge circuit when switching off the charging tube; and switches off the pull-down discharge circuit when detecting a trigger signal. The pull-down discharge circuit pulls down a gate voltage of the charging tube to a ground potential so as to discharge fast, when being switched on. The discharge detection circuit generates and transmits the trigger signal to the control circuit, when the gate voltage of the charging tube drops to a low-level threshold or a pull-down time of the charging tube reaches a time threshold, after the pull-down discharge circuit is switched on. The fast switch-off circuit ensures fast switch-off for a charging tube of a battery management system, while minimizing power consumption.

### CROSS REFERENCE TO RELATED APPLICATIONS

The present application claims the benefit of Chinese Patent Application No. 202410709381.4 filed on Jun. 3, 2024, the contents of which are incorporated herein by reference in their entirety.

### TECHNICAL FIELD

This disclosure relates generally to a technical field of a battery management system, and more particularly relates to a fast switch-off circuit for a charging tube of a battery management system.

### BACKGROUND

A charging tube in a battery Management System (BMS) is directly connected with a load or a charger. The charging tube is usually a MOS tube, and both positive and negative voltages may be applied to a source of the MOS tube. Therefore, a drive circuit of the charging tube usually has an open-drain output, and a resistor R1 is connected between a gate and a source of the charging tube. When the charging tube is switched off, its drive circuit outputs a high resistance state, and discharges an input capacitor of the charging tube (an equivalent capacitor between the gate and the source of the charging tube) through a resistor R1, so as to switch off the charging tube. In applications with large charging and discharging currents, the charging tube requires a high-power charging and discharging MOSFET, which means that an input capacitance of the MOSFET is very large, which may reach a magnitude of tens of nano-farads (nF). If an abnormal event, such as overcurrent, overvoltage, or overheating, occurs, the charging tube needs to be quickly switched off to ensure system safety. This requires the resistor R1 to be as small as possible to ensure that a discharging current is large enough such that the charging tube can be quickly switched off. However, choosing a smaller resistance value for the resistor R1 means that the system has greater power consumption during normal operation or standby. To reduce power consumption, the resistance value of the resistor R1 needs to be increased. If the resistance value of the resistor R1 is increased, the discharging current is decreased, which results in that the input capacitor of the charging tube discharges for too long, making it difficult to quickly switch off the charging tube, and resulting in a safety hazard. In summary, it is currently impossible to ensure fast switch-off for a charging tube of a battery management system, while minimizing power consumption.

### SUMMARY

This disclosure has provided a fast switch-off circuit for a charging tube of a battery management system, aimed at a technical problem mentioned above that it is currently impossible to ensure a fast switching-off for a charging tube of a battery management system, while minimizing power consumption.

According to a first aspect, a fast switch-off circuit for a charging tube of a battery management system is provided, wherein a resistor with a resistance value which is greater than a preset resistance value, is connected between a gate and a source of the charging tube, wherein the preset resistance value is preset based on a power consumption requirement of the battery management system; wherein the fast switch-off circuit for a charging tube includes a control circuit, a pull-down discharge circuit, and a discharge detection circuit; wherein:
the control circuit is configured to synchronously switch on the pull-down discharge circuit, when switching off the charging tube; the control circuit is further configured to switch off the pull-down discharge circuit when detecting a trigger signal which is transmitted by the discharge detection circuit;
the pull-down discharge circuit is connected with the gate of charging tube; wherein the pull-down discharge circuit is configured to pull down a gate voltage of the charging tube to a ground potential for discharging, when the pull-down discharge circuit is switched on;
the discharge detection circuit is connected with the control circuit; wherein discharge detection circuit is configured to generate and transmit the trigger signal to the control circuit, when the gate voltage of the charging tube drops to a low-level threshold or a pull-down time of the charging tube reaches a time threshold, after the pull-down discharge circuit is switched on.

Preferably, the discharge detection circuit includes a first voltage detection circuit, wherein a detection terminal of the first voltage detection circuit is connected with the gate of the charging tube, and an output terminal of the first voltage detection circuit is connected with the control circuit; the first voltage detection circuit is configured to compare a voltage at the detection terminal of the first voltage detection circuit with a reference voltage which corresponds to the low-level threshold, configured to output a low/high level when the voltage at the detection terminal is greater than the reference voltage, and configured to generate the trigger signal by flipping an output level of the first voltage detection circuit, when the voltage at the detection terminal is lower than the reference voltage.

Preferably, the discharge detection circuit includes a first timer circuit, which is connected with the control circuit; wherein the first timer circuit is configured to start timing and output a low/high level when the pull-down discharge circuit is switched on, and configured to generate the trigger signal by flipping an output level of the first timer circuit, when a timed time reaches the time threshold.

Preferably, the discharge detection circuit includes:
a second voltage detection circuit, wherein a detection terminal of the second voltage detection circuit is connected with the gate of the charging tube; wherein the second voltage detection circuit is configured to compare a voltage at the detection terminal of the second voltage detection circuit with a reference voltage which corresponds to the low-level threshold, configured to output a low/high level when the voltage at the detection terminal is greater than the reference voltage, and configured to generate a first output signal by flipping an output level of the second voltage detection circuit, when the voltage at the detection terminal is lower than the reference voltage;
a second timer circuit, which is connected with the control circuit; wherein the second timer circuit is configured to start timing and output a low/high level when the pull-down discharge circuit is switched on, and configured to generate a second output signal by flipping an output level of the second timer circuit, when a timed time reaches the time threshold;
a combination processing circuit, wherein two input terminals of the combination processing circuit are connected with output terminals of the second voltage detection circuit and the second timer circuit, respectively; wherein the combination processing circuit is configured to output the trigger signal when detecting the first output signal or the second output signal.

Preferably, the trigger signal, the first output signal, and the second output signal, are all high levels, the combination processing circuit includes an OR gate.

Preferably, the trigger signal, the first output signal, and the second output signal, are all low levels, the combination processing circuit includes an AND gate.

Preferably, the pull-down discharge circuit includes an electronic switch which is connected between the gate of the charging tube and ground, wherein a control terminal of the electronic switch is connected with the control circuit.

Preferably, the fast switch-off circuit for a charging tube further includes a drive circuit, wherein a controlled terminal of the drive circuit is connected with the control circuit, and the drive circuit is connected between the gate of the charging tube and an internal power supply, the control circuit is configured to switch off the drive circuit and synchronously switch on the pull-down discharge circuit, when the charging tube needs to be switched off.

Preferably, the charging tube is a MOSFET, a diode is connected between the gate and the source of the charging tube; wherein a positive pole of the diode is connected with the source of the charging tube, and a negative pole of the diode is connected with the gate of the charging tube.

The fast switch-off circuit for a charging tube of a battery management system in this disclosure has following beneficial effects. The resistance value of the resistor between the gate and source of the charging tube in this disclosure is greater than a preset resistance value, thereby solving the power consumption problem caused by too small resistance. At the same time, the pull-down discharge circuit is synchronously switched on to quickly discharge the charging tube, when the charging tube is switched off; and the pull-down discharge circuit is switched off, when the gate voltage of the charging tube drops to a low-level threshold or the pull-down time reaches a time threshold. That is, when the charging tube is switched off, a discharging speed of the capacitor no longer depends solely on the resistance between the gate and source of the charging tube. On the contrary, the charging tube is discharged and switched off quickly by pulling down the gate voltage of the charging tube to a ground potential. In summary, this disclosure is capable of ensuring a fast switching-off for a charging tube of a battery management system, while minimizing power consumption.

### BRIEF DESCRIPTION OF THE DRAWINGS

In order to illustrate the embodiments of this disclosure or the technical solutions in the prior art more clearly, the drawings needed in the description of the embodiments or the prior art will be briefly introduced. It is obvious that the drawings in the following description are only the embodiments of this disclosure, and for one skilled in the art, other drawings can be obtained from the following attached drawings without paying creative labor.

FIG. 1 is a diagram of a fast switch-off circuit for a charging tube of a battery management system according to an embodiment of this disclosure.

FIG. 2 is a structural diagram of a fast switch-off circuit for a charging tube of a battery management system according to a first embodiment of this disclosure.

FIG. 3 is a waveform diagram of the first embodiment of this disclosure.

FIG. 4 is a structural diagram of a fast switch-off circuit for a charging tube of a battery management system according to a second embodiment of this disclosure.

FIG. 5 is a waveform diagram of the second embodiment of this disclosure.

FIG. 6 is a structural diagram of a fast switch-off circuit for a charging tube of a battery management system according to a third embodiment of this disclosure.

### DETAILED DESCRIPTION OF THE PREFERRED EMBODIMENT

In order to facilitate the understanding of this disclosure, a more comprehensive description of this disclosure will be given as follows with reference to the relevant drawings. Typical embodiments of this disclosure are shown in the drawings. However, this disclosure can be implemented in many different forms and is not limited to the embodiments described herein. On the contrary, the purpose of providing these embodiments is to make the description of this disclosure more thorough and comprehensive. It should be understood that the embodiments of this disclosure and the specific features in the embodiments are detailed explanations of the technical solution of this disclosure, rather than limitations on the technical solution of this disclosure. The embodiments of this disclosure and the technical features in the embodiments may be combined with each other without conflicts.

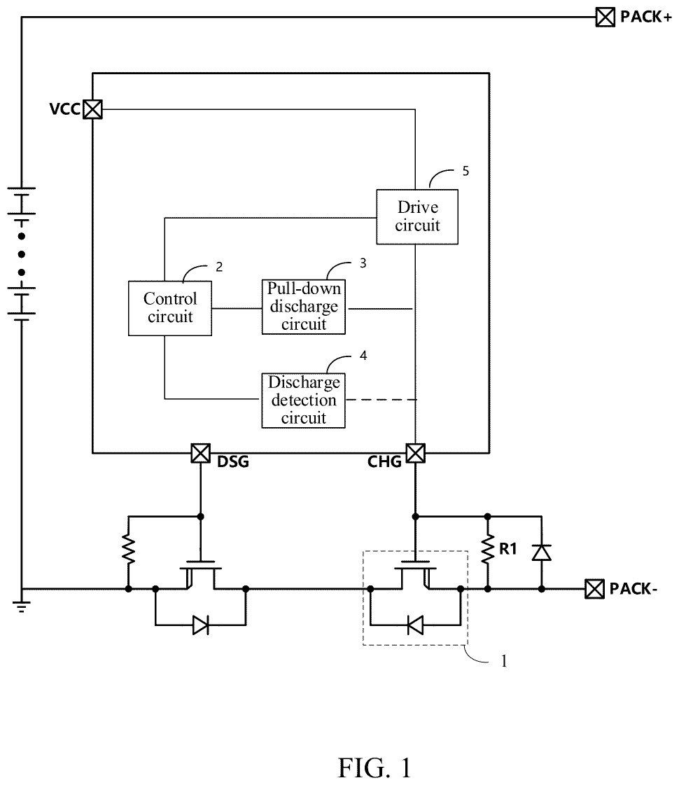

FIG. 1 is a diagram of a fast switch-off circuit for a charging tube of a battery management system according to an embodiment of this disclosure. Referring to FIG. 1, PACK+ and PACK− respectively represent positive and negative output terminals of a battery management system, and are connected with positive and negative terminals of a load. A source of a charging tube 1 is connected with negative output terminal PACK−, and a drain of the charging tube 1 is connected with a battery ground potential through a discharge tube. A resistor R1 is connected between the gate and the source of the charging tube 1, which is a MOSFET. A diode is also connected between the gate and the source of the charging tube 1. A anode of the diode is connected with the source of the charging tube 1, and a cathode of the diode is connected with the gate of the charging tube 1.

On the one hand, based on a power consumption requirement of the battery management system, a resistance value of the resistor R1 is set to be greater than a preset resistance value. On the other hand, a control circuit 2, a pull-down discharge circuit 3, a discharge detection circuit 4, and a drive circuit 5 are provided.

Wherein a controlled end of the drive circuit 5 is connected with the control circuit 2, and the drive circuit 5 is connected between the gate of the charging tube 1 and an internal power supply VCC. The drive circuit 5 includes a drive tube. The specific arrangement of the drive circuit 5 is known to one skilled in the art and is not repeated here.

The control circuit 2 is configured to switch off the drive circuit 5 and synchronously switch on the pull-down discharge circuit 3, when the charging tube 1 is needed to be switched off. The control circuit 2 is further configured to switch off the pull-down discharge circuit 3 when detecting a trigger signal which is transmitted by the discharge detection circuit 4.

Wherein, the pull-down discharge circuit 3 is connected with the gate of the charging tube 1, and configured to pull down a gate voltage of the charging tube 1 to a ground potential so as to discharge fast, when the pull-down discharge circuit 3 is switched on.

Wherein, the discharge detection circuit 4 is connected with the control circuit 2, and configured to generate and transmit the trigger signal to the control circuit 2 when the gate voltage of the charging tube 1 drops to a low-level threshold or a pull-down time reaches a time threshold, after the pull-down discharge circuit 3 is switched on. A dashed line in the drawings indicates that the discharge detection circuit 4 may also be connected with the gate of the charging tube 1. For example, if the discharge detection circuit 4 detects the gate voltage of the charging tube 1, then the dashed line indicates that the discharge detection circuit 4 is further connected with the gate of the charging tube 1.

Because a discharge during the switching-off process of the charging tube 1 is mainly achieved through the pull-down discharge circuit 3, rather than entirely depending on the resistor R1 between the gate and the source of the charging tube 1, the resistance value of the resistor R1 no long needs to considering the discharge current. The resistance value of the resistor R1 can mainly consider the power consumption problem. For example, in this disclosure, the resistance value of the resistor R1 is set to be greater than the preset resistance value, which can solve the power consumption problem caused by the resistor R1 being too small. For example, if the gate voltage of the charging tube is 12V and a resistance value of the resistor R1 is set to IM, the power consumption will be 12 uA. Accordingly, the resistance value of the resistor R1 can be increased to reduce power consumption. Therefore, this disclosure is capable of ensuring a fast switching-off for a charging tube of a battery management system, while minimizing power consumption.

Below are three specific embodiments.

### Embodiment 1

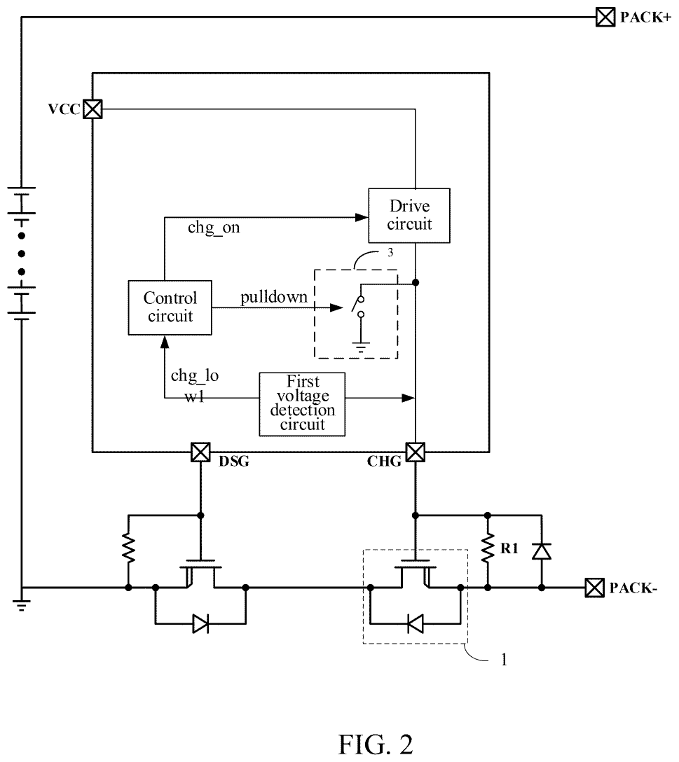

FIG. 2 is a structural diagram of a fast switch-off circuit for a charging tube of a battery management system according to a first embodiment of this disclosure. In this embodiment, the pull-down discharge circuit 3 includes an electronic switch which is connected between the gate of the charging tube and ground, such as a MOS transistor, a transistor, etc. A control terminal of the electronic switch is connected with the control circuit 2. In this embodiment, the pull-down discharge circuit 3 is specifically an NMOS transistor. The control circuit 2 can be constructed by any controller, micro controller, microprocessor which are capable of generating control logic signals. One skilled in the art are capable of constructing such control circuit 2 according to this disclosure and common technical knowledge in the present art.

The discharge detection circuit 4 includes a first voltage detection circuit, a detection terminal of the first voltage detection circuit is connected with the gate of the charging tube 1, and an output terminal of the first voltage detection circuit is connected with the control circuit 2. The first voltage detection circuit is configured to compare a voltage at the detection terminal of the first voltage detection circuit with a reference voltage which corresponds to a low-level threshold Vth. When the voltage at the detection terminal is greater than the reference voltage, the first voltage detection circuit outputs a low level. When the voltage at the detection terminal is lower than the reference voltage, the first voltage detection circuit generates the trigger signal by flipping an output level of the first voltage detection circuit, i.e., the trigger signal is a high level which is generated by flipping the outputted low level.

For example, the first voltage detection circuit can be composed of a voltage sampling circuit and a comparison circuit. The comparison circuit can comprises a comparator. The voltage sampling circuit can be a voltage division circuit composed of a single resistor or multiple resistors. For example, if the voltage sampling circuit consists of two voltage division resistors, these two voltage division resistors can be connected in series between the gate of the charging tube 1 and ground. A connection node of the two voltage division resistors is the detection terminal. Wherein the detection terminal is connected with a negative input terminal of the comparator, and a positive input terminal of the comparator is connected with the reference voltage. Assuming that a voltage division ratio of the voltage sampling circuit is K, that is, the ratio of the voltage at the detection terminal to the voltage at the gate of the charging tube 1 is K, a magnitude of the reference voltage can be obtained by multiplying the preset low-level threshold Vth by K, wherein the preset low-level threshold Vth is preset according to a gate voltage threshold when the charging tube 1 is switched off. As noted by one skilled in the art, the gate voltage threshold can be known from manufacturer of the charging tube 1.

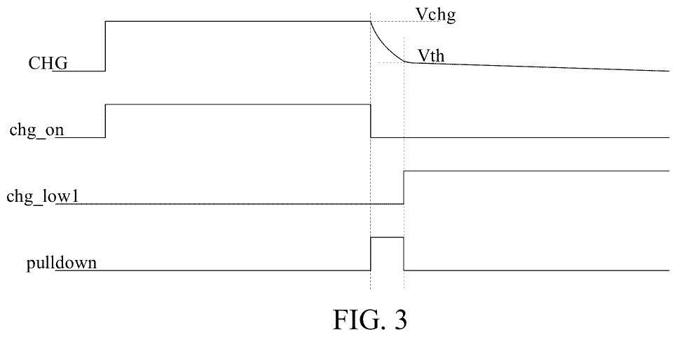

Referring to FIG. 3, a working principle of this embodiment is as follows. When the charging tube 1 is required to be switched on, a switching signal chg_on, which is transmitted to the drive circuit 5 from the control circuit, jumps from a low level to a high level, and the drive circuit 5 charges the input gate capacitor of the charging tube 1, so as to enable the gate voltage CHG of the charging tube 1 to increase to a voltage Vchg. When the charging tube 1 is required to be switched off, the switching signal chg_on jumps from a high level to a low level, and a switching signal pulldown which is transmitted to the pull-down discharge circuit 3 from the control circuit, jumps from a low level to a high level. The pull-down discharge circuit 3 is switched on, and the charging tube 1 is quickly switched off by a fast discharge of the pull-down discharge circuit 3. The gate voltage CHG of the charging tube 1 decreases. When the gate voltage CHG of the charging tube 1 drops to the reference voltage, which is preset by the first voltage detection circuit (as discussed above, the reference voltage is preset according to the low-level threshold Vth, and the low-level threshold Vth is preset according to a gate voltage threshold when the charging tube 1 is switched off), an output signal chg_low1, which is outputted by the first voltage detection circuit, jumps from a low level to a high level, which forms the triggering signal. When the control circuit 2 receives the triggering signal, the control circuit 2 switches off the pull-down discharge circuit 3, such that the switching signal pulldown flips from a high level to a low level.

In summary, the first voltage detection circuit can detect a switch state of the charging tube 1 in real time, and the pull-down discharge circuit 3 is configured to achieve fast discharge of the input capacitor of the charging tube 1, thereby ensuring that charging tube 1 is quickly switched off and improving the system safety index while minimizing power consumption.

Of course, in other embodiments, the trigger signal can also be a low level, which is a simple variation of this embodiment.

### Embodiment 2

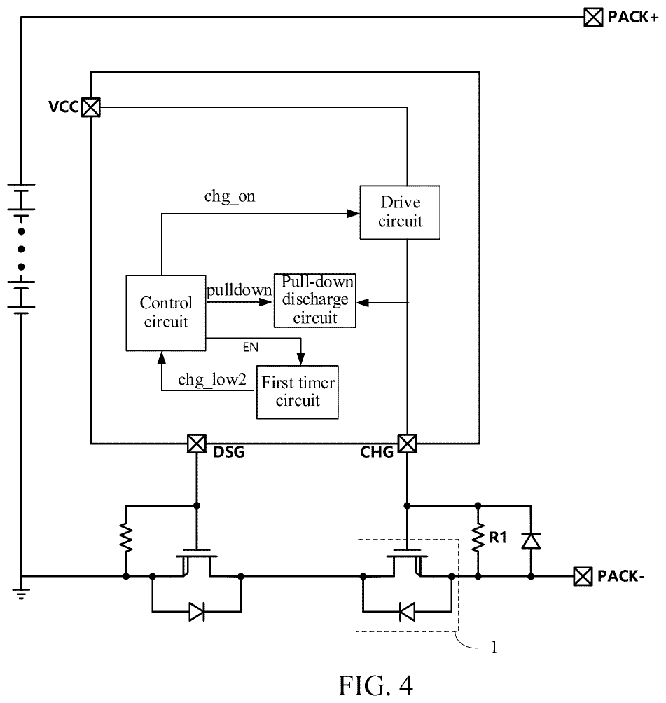

Referring to FIG. 4, the discharge detection circuit 4 in this embodiment includes a first timer circuit, which is connected with the control circuit 2. The first timer circuit is configured to start timing and output a low level, when the pull-down discharge circuit 3 is switched on. When the timed time reaches a time threshold, the outputted low level is flipped to form the trigger signal, that is, the trigger signal is also a high level. When the control circuit switches off the drive circuit 5 of the charging tube 1, the control circuit synchronously set an enable terminal of the first timer circuit to 1. When receiving the trigger signal which is transmitted by the first timer circuit, the control circuit set the enable terminal of the first timer circuit to 0.

Wherein, the time threshold is related to a size of the charging tube and of the resistor R1. The larger the size of the charging tube, the larger its equivalent gate source capacitor, and the longer a discharging time, so the time threshold needs to be set longer. The time threshold can be calculated according to following equation:

$$I = C * ( d V / dt ) .$$

Wherein, I represents the pull-down current; C represents the equivalent capacitance value between the source and the gate of the charging tube, which is associated with the size of the charging tube and can be obtained from the producer, V represents the gate voltage, t represents the time threshold.

The charging tube has two discharge paths, one discharge path is the resistor R1 and the other discharge path is the pull-down discharge circuit 3. When the resistance value of the resistor R1 is larger, a current on the resistor R1 is smaller, and the discharge ability of the resistor R1 is weaker. Therefore, it mainly relies on the pull-down discharge circuit 3 for discharge. The longer the discharging time, the larger the time threshold needs to be set.

The first timer circuit can use any existing countdown timer, or can be implemented by using a digital counter and a digital comparator. For example, the digital counter receives an enable signal from the control circuit 2, and a counting output terminal of the digital counter is connected with a negative input of the digital comparator. A positive input terminal of the digital comparator is a fixed value (which can be determined by dividing the time threshold by a period which corresponds to a system frequency).

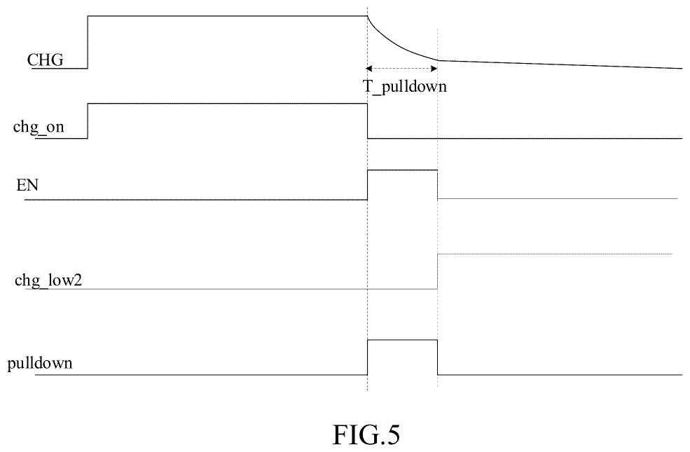

Referring to FIG. 5, a working principle of this embodiment is as follows. When the charging tube 1 is required to be switched on, a switching signal chg_on, which is transmitted to the drive circuit 5 from the control circuit, jumps from a low level to a high level, and the drive circuit 5 charges the input gate capacitor of the charging tube 1, so as to enable the gate voltage CHG of the charging tube 1 to increase to a voltage Vchg. When the charging tube 1 is required to be switched off, the switching signal chg_on jumps from a high level to a low level, and a switching signal pulldown which is transmitted to the pull-down discharge circuit 3 from the control circuit, jumps from a low level to a high level. The pull-down discharge circuit 3 is switched on, and an enable signal EN of the first timer circuit is also synchronously set to 1 to start timing. At this time, the charging tube 1 is quickly switched off by a fast discharge of the pull-down discharge circuit 3. When a timed time of the first timer circuit reaches a time threshold T_pulldown, the output signal chg_low2 of the first timer circuit jumps from a low level to a high level, which forms the triggering signal. When the control circuit 2 receives the triggering signal, the control circuit 2 switches off the pull-down discharge circuit 3, such that the switching signal pulldown flips from a high level to a low level. The pull-down discharge circuit 3 is switched off, and meanwhile the control circuit resets the enable signal EN of the first timer circuit to 0.

In summary, by setting the time for pull-down discharge, it is ensured that charging tube 1 can be switched off within the required time.

### Embodiment 3

According to further study, the fast switch-off circuit for a charging tube of a battery management system according to embodiment 1, may have a following technical problem. When the BMS is in a discharge state, the load is too small or short-circuited to pull up a voltage at the negative output terminal PACK− to be VCC, the gate voltage of the charging tube 1 will always remain at VCC, the output signal chg_low1 of the first voltage detection circuit will remain at a low level, and the pull-down discharge circuit 3 will remain in an on state. There is a situation where the positive output terminal PACK+ leaks an electrical current to the circuit, such that the charging tube 1 cannot be switched off, which poses a safety hazard. According to further study, the fast switch-off circuit for a charging tube of a battery management system according to embodiment 2, may have a following technical problem. In applications with a large charging current, the charging tube 1 requires a high-power MOSFET, which means that the input capacitance of MOSFET is very large, which may reach a magnitude of tens of nano-farads (nF). If the time threshold for the pull-down discharge is set to be too short, the pull-down discharge circuit 3 has already been switched off before the switching off of the charging tube 1. Then the input capacitor of the charging tube 1 is discharged by the resistor R1, which may not satisfy the fast switching-off of the charging tube 1. Therefore, the time threshold for the pull-down discharge needs to be as large as possible to be compatible with most application scenarios. However, there are also the following problem. After pulling down the gate voltage of the charging tube 1 to ground potential through the pull-down discharge circuit 3, the pull-down discharge circuit 3 is still in the on state. At this time, if there is a BMS charger or load, there is still an internal leakage in the circuit, such that the power consumption increases. Therefore, in response to the above issues, the first embodiment and the second embodiment are combined to give a more preferable embodiment as follows.

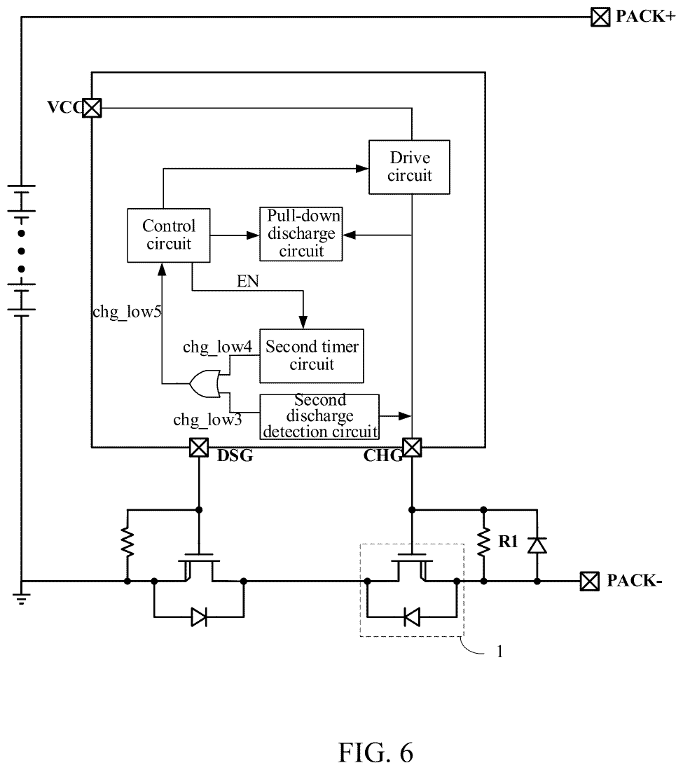

Referring to FIG. 6, the discharge detection circuit 4 described in this embodiment includes a second voltage detection circuit, a second timer circuit, and a combination processing circuit.

A detection terminal of the second voltage detection circuit is connected with the gate of the charging tube; wherein the second voltage detection circuit is configured to compare a voltage at the detection terminal of the second voltage detection circuit with a reference voltage which corresponds to the low-level threshold, configured to output a low level when the voltage at the detection terminal is greater than the reference voltage, and configured to generate a second output signal by flipping an output level of the second voltage detection circuit, when the voltage at the detection terminal is lower than the reference voltage.—The specific implementation of the second voltage detection circuit can refer to the first voltage detection circuit in embodiment 1.

The second timer circuit is connected with the control circuit; wherein the second timer circuit is configured to start timing and output a low level when the pull-down discharge circuit is switched on, and configured to generate a second output signal by flipping an output level of the second timer circuit, when a timed time reaches the time threshold. The specific implementation of the second timer circuit can refer to the first timer circuit in embodiment 1.

Two input terminals of the combination processing circuit are connected with output terminals of the second voltage detection circuit and the second timer circuit, respectively; wherein the combination processing circuit is configured to output the trigger signal when detecting the first output signal or the second output signal. In this embodiment, the trigger signal and the first output signal, and the second output signal are all high levels, and the combination processing circuit includes an OR gate. It can be understood that in other embodiments, the trigger signal, the first output signal, and the second output signal can all be low levels, and the combination processing circuit can include an AND gate.

A working principle of this embodiment is as follows. When the charging tube 1 is required to be switched on, a switching signal chg_on, which is transmitted to the drive circuit 5 from the control circuit, jumps from a low level to a high level, and the drive circuit 5 charges the input gate capacitor of the charging tube 1, so as to enable the gate voltage CHG of the charging tube 1 to increase to a voltage Vchg. When the charging tube 1 is required to be switched off, the switching signal chg_on jumps from a high level to a low level, and a switching signal pulldown which is transmitted to the pull-down discharge circuit 3 from the control circuit, jumps from a low level to a high level. The pull-down discharge circuit 3 is switched on, and an enable signal EN of the second timer circuit is also synchronously set to 1 to start timing. At this time, the charging tube 1 quickly discharges through the pull-down discharge circuit 3. The gate voltage CHG of the charging tube 1 decreases.

Before a timed time of the second timer circuit reaches the time threshold T_pulldown, if the gate voltage CHG drops to the reference voltage which is preset by the second voltage detection circuit, the output signal chg_low3 of the second voltage detection circuit jumps from a low level to a high level, and the output signal chg_low5 of the OR gate also jumps to a high level, which forms the triggering signal. When the control circuit 2 receives the triggering signal, the control circuit 2 switches off the pull-down discharge circuit 3, such that the switching signal pulldown flips from a high level to a low level. The pull-down discharge circuit 3 is switched off, and meanwhile the control circuit resets the enable signal EN of the second timer circuit to 0.

If the gate voltage of the charging tube is maintained at the voltage VCC, when the timed time of the second timer circuit reaches the time threshold T_pulldown, the output signal chg_low4 of the second timer circuit jumps to a high level, and the output signal chg_low5 of the OR gate also jumps to a high level, which forms the triggering signal. When the control circuit 2 receives the triggering signal, the control circuit 2 switches off the pull-down discharge circuit 3, such that the switching signal pulldown flips from a high level to a low level. The pull-down discharge circuit 3 is switched off, and meanwhile the control circuit resets the enable signal EN of the second timer circuit to 0. In this case, the pull-down discharge circuit 3 is switched off, and the discharge of the charging tube 1 mainly relies on the external resistor R1.

In this embodiment, even if the BMS is in a discharge state, the load is too small or short circuited to pull up a voltage at the negative output terminal PACK− to be VCC, the second timer circuit still will inevitably trigger the pull discharge circuit 3 to be switched off, when the timing reaches the time threshold T_pulldown. In this way, charging tube can still be switched off in a timely manner. In this embodiment, the second voltage detection circuit detects the gate voltage of the charging tube in real time. When the gate voltage is detected to be lower than the low-level threshold Vth, the pull-down discharge circuit 3 is immediately switched off. Therefore, the time threshold T_pulldown of the pull-down discharge, can be set to a relatively large value as much as possible. The leakage problem caused by the excessive large time threshold T_pulldown in embodiment 2, never exists now.

The fast switch-off circuit for a charging tube of a battery management system in this disclosure has following beneficial effects. The resistance value of the resistor between the gate and source of the charging tube in this disclosure is greater than a preset resistance value, thereby solving the power consumption problem caused by too small resistance. At the same time, the pull-down discharge circuit is synchronously switched on to quickly discharge the charging tube, when the charging tube is switched off; and the pull-down discharge circuit is switched off, when the gate voltage of the charging tube drops to a low-level threshold or the pull-down time reaches a time threshold. That is, when the charging tube is switched off, a discharging speed of the capacitor no longer depends solely on the resistance between the gate and source of the charging tube. On the contrary, the charging tube is discharged and switched off quickly by pulling the gate voltage of the charging tube to a ground potential. In summary, this disclosure is capable of ensuring a fast switching-off for a charging tube of a battery management system, while minimizing power consumption.

Unless otherwise defined, all technical and scientific terms used in this disclosure have the same meanings as those commonly understood by those skilled in the art belonging to this disclosure. The terms used in the description of this disclosure are only for the purpose of describing specific embodiments and are not intended to limit this disclosure.

The terms “first”, “second” and other ordinal numbers used in this specification can be used to describe but not limit the various constituent elements. The purpose of using these terms is to distinguish one constituent element from the other. For example, without departing from the scope of this disclosure, the first constituent element can be named as the second constituent element, and similarly, the second constituent element can also be named as the first constituent element. The “connect with” or “connect to” mentioned herein not only includes the direct connection of two entities, but also includes the indirect connection through other entities with beneficial improvement effect. The terms “equal to”, “equivalent to”, “at the same time”, “synchronous” or other similar terms are not limited to absolute equal or identical in mathematical terms. When implementing the embodiments described in this disclosure, they can be similar in engineering sense or within acceptable error range.

The embodiments of this disclosure are described above in combination with the drawings, but this disclosure is not limited to the above specific embodiments. The above specific embodiments are only schematic, not restrictive. Ordinary technicians in the art can make many forms under the enlightenment of this disclosure and without departing from the scope of the purpose and claims of this disclosure, and these are within the protection of this disclosure.

1. A fast switch-off circuit for a charging tube of a battery management system, wherein a resistor with a resistance value which is greater than a preset resistance value, is connected between a gate and a source of the charging tube, wherein the preset resistance value is preset based on a power consumption requirement of the battery management system; wherein the fast switch-off circuit for a charging tube comprises a control circuit, a pull-down discharge circuit, and a discharge detection circuit; wherein:
the control circuit is configured to synchronously switch on the pull-down discharge circuit, when switching off the charging tube; the control circuit is further configured to switch off the pull-down discharge circuit when detecting a trigger signal which is transmitted by the discharge detection circuit;
the pull-down discharge circuit is connected with the gate of charging tube; wherein the pull-down discharge circuit is configured to pull down a gate voltage of the charging tube to a ground potential for discharging, when the pull-down discharge circuit is switched on;
the discharge detection circuit is connected with the control circuit; wherein discharge detection circuit is configured to generate and transmit the trigger signal to the control circuit, when the gate voltage of the charging tube drops to a low-level threshold or a pull-down time of the charging tube reaches a time threshold, after the pull-down discharge circuit is switched on.

2. The fast switch-off circuit for a charging tube of a battery management system according to claim 1, wherein the discharge detection circuit comprises a first voltage detection circuit, wherein a detection terminal of the first voltage detection circuit is connected with the gate of the charging tube, and an output terminal of the first voltage detection circuit is connected with the control circuit; the first voltage detection circuit is configured to compare a voltage at the detection terminal of the first voltage detection circuit with a reference voltage which corresponds to the low-level threshold, configured to output a low/high level when the voltage at the detection terminal is greater than the reference voltage, and configured to generate the trigger signal by flipping an output level of the first voltage detection circuit, when the voltage at the detection terminal is lower than the reference voltage.

3. The fast switch-off circuit for a charging tube of a battery management system according to claim 1, wherein the discharge detection circuit comprises a first timer circuit, which is connected with the control circuit; wherein the first timer circuit is configured to start timing and output a low/high level when the pull-down discharge circuit is switched on, and configured to generate the trigger signal by flipping an output level of the first timer circuit, when a timed time reaches the time threshold.

4. The fast switch-off circuit for a charging tube of a battery management system according to claim 1, wherein the discharge detection circuit comprises:
a second voltage detection circuit, wherein a detection terminal of the second voltage detection circuit is connected with the gate of the charging tube; wherein the second voltage detection circuit is configured to compare a voltage at the detection terminal of the second voltage detection circuit with a reference voltage which corresponds to the low-level threshold, configured to output a low/high level when the voltage at the detection terminal is greater than the reference voltage, and configured to generate a first output signal by flipping an output level of the second voltage detection circuit, when the voltage at the detection terminal is lower than the reference voltage;
a second timer circuit, which is connected with the control circuit; wherein the second timer circuit is configured to start timing and output a low/high level when the pull-down discharge circuit is switched on, and configured to generate a second output signal by flipping an output level of the second timer circuit, when a timed time reaches the time threshold;
a combination processing circuit, wherein two input terminals of the combination processing circuit are connected with output terminals of the second voltage detection circuit and the second timer circuit, respectively; wherein the combination processing circuit is configured to output the trigger signal when detecting the first output signal or the second output signal.

5. The fast switch-off circuit for a charging tube of a battery management system according to claim 4, wherein the trigger signal, the first output signal, and the second output signal, are all high levels, the combination processing circuit comprises an OR gate.

6. The fast switch-off circuit for a charging tube of a battery management system according to claim 4, wherein the trigger signal, the first output signal, and the second output signal, are all low levels, the combination processing circuit comprises an AND gate.

7. The fast switch-off circuit for a charging tube of a battery management system according to claim 1, wherein the pull-down discharge circuit comprises an electronic switch which is connected between the gate of the charging tube and ground, wherein a control terminal of the electronic switch is connected with the control circuit.

8. The fast switch-off circuit for a charging tube of a battery management system according to claim 1, further comprising a drive circuit, wherein a controlled terminal of the drive circuit is connected with the control circuit, and the drive circuit is connected between the gate of the charging tube and an internal power supply, the control circuit is configured to switch off the drive circuit and synchronously switch on the pull-down discharge circuit, when the charging tube needs to be switched off.

9. The fast switch-off circuit for a charging tube of a battery management system according to claim 1, wherein the charging tube is a MOSFET, a diode is connected between the gate and the source of the charging tube; wherein a positive pole of the diode is connected with the source of the charging tube, and a negative pole of the diode is connected with the gate of the charging tube.
